(19) United States
(12) Patent Application Publication
(10) Pub. No.: US 2013/0169671 A1
(43) Pub. Date: Jul. 4, 2013

(54) PROJECTOR AND METHOD FOR CONTROLLING IMAGE DISPLAY OF THE SAME

(71) Applicant: Hitachi Consumer Electronics Co., Ltd., Tokyo (JP)

(72) Inventors: Kenichi IWAHARA, Yokohama (JP); Koichi ATSUTA, Yokohama (JP); Nobutaka HOTTA, Fujisawa (JP); Masaaki TAKATSUJI, Chigasaki (JP); Atsushii MARUYAMA, Yokohama (JP)

(73) Assignee: HITACHI CONSUMER ELECTRONICS CO., LTD., Tokyo (JP)

(21) Appl. No.: 13/714,477

(22) Filed: Dec. 14, 2012

(30) Foreign Application Priority Data
Dec. 28, 2011 (JP) 2011-287367

(51) Int. Cl. G06T 11/60

(52) U.S. Cl. CPC G06T 11/60
USPC 345/619

(57) ABSTRACT

A projector in which an additional writing image is synthesized with a projection image and the synthesized image is projected and displayed includes: a display memory storing trapezoidal distortion corrected projection image information; a pen drawing control part forming an additional writing image by straight line drawing based on display position information of an inputted additional writing image and corrects trapezoidal distortion; and an OSD memory storing additional writing image information generated in the pen drawing control part and having corrected trapezoidal distortion, in which image information in the display memory and image information in the OSD memory are synthesized and displayed. Recording of projection image information into an external storage device includes setting an output image to BLANK; storing a projection image without correcting trapezoidal distortion into the display memory; and synthesizing the contents of the display memory and the additional writing image to into the external storage device.

### FIELD OF THE INVENTION

The present invention relates to a projector which can project an image onto a whiteboard, and can synthesize and display an additional writing image by a coordinate pointing means such as an electronic pen and a mouse, and a method for controlling image display of the projector.

### BACKGROUND OF THE INVENTION

There are projector systems which display documents for presentations and meetings to a plurality of users by projecting the documents onto a screen or a whiteboard. Of these systems, some systems can store an additional writing image on the whiteboard for supplemental explanation by taking the image using a digital camera or the like. However, high quality images cannot be stored by the method of directly taking the image from the whiteboard. Consequently, when the image in which the additional writing is written on the whiteboard is taken, there is a technique in which the additional writing image is taken by projecting a blank image, and the taken additional writing image and the projection image of the document or the like are synthesized to store, and thereby a high quality image can be stored (for example, Japanese Unexamined Patent Application Publication No. 2011-84050).

In addition, there is a system which displays an additional writing image using an electronic pen which is made by digitizing a marker for a whiteboard. When this electronic pen is used, a position detection device is attached to the whiteboard and a swept trajectory of the electronic pen when a user writes on the whiteboard is calculated by position calculation based on a principle of triangulation to project the swept trajectory onto the whiteboard as writing information. There is another system in which an operation instruction can be performed with a specific area on the whiteboard as a command instruction area by using the electronic pen (for example Japanese Unexamined Patent Application Publication No. 2008-122749).

### SUMMARY OF THE INVENTION

In the related art described above, however, a positional relationship between a screen or a whiteboard and a projector is not considered and trapezoidal distortion of a projection image, which is generated when a normal direction of the screen or the whiteboard and a projection direction of the projector are misaligned, is also not considered.

In a recent projector, the trapezoidal distortion correction is generally controlled by an image processing LSI, and projection of a synthesized image with the additional writing image and recording of the projection image are difficult to perform by using such an LSI.

A purpose of the present invention is to provide solutions for the above described problems, realization of projection display of the synthesized image with the additional writing image in a low price, and a projector which can record the image in high quality.

In order to solve the problems described above, a projector of the present invention in which an additional writing image is synthesized with a projection image and the synthesized image is projected and displayed, the projector includes: a display memory which stores trapezoidal distortion corrected projection image information; a pen drawing control part which forms an additional writing image by straight line drawing based on display position information of an inputted additional writing image and corrects trapezoidal distortion; and an OSD memory which stores additional writing image information being generated in the pen drawing control part and in which trapezoidal distortion is corrected, in which image information in the display memory and image information the OSD memory are synthesized and displayed.

In addition, a method for controlling image display of a projector in which an additional writing image is synthesized with a projection image and the synthesized image is projected and displayed, the method includes the steps of: inputting pieces of coordinate information of an additional writing image which is synthesized with a projection image and displayed; drawing a straight line of which the pieces of coordinate information are used as edge parts; transforming a coordinate of projection image information in accordance with a correction amount of trapezoidal distortion; transforming a coordinate of the additional writing image in which the straight line is drawn in accordance with a correction amount of trapezoidal distortion; synthesizing the coordinate transformed projection image information with the coordinate transformed additional writing image information; and magnifying and projecting the synthesized projection image information.

According to the aspects of the present invention, a projector which can synthesize and display an additional writing image having excellent image quality, even when the image is obliquely projected and displayed, can be realized in a low price. The projector also can record the synthesized and displayed projection image.

### BRIEF DESCRIPTION OF THE DRAWINGS

FIG. 1 is a diagram illustrating a constitution of projector in an embodiment;

FIG. 2 is a schematic view illustrating an aspect in which a display image and an additional writing image are synthesized, and trapezoidal distortion of the synthesized image is corrected and projected;

FIG. 3 is a flow chart of display control of the additional writing image;

FIG. 4 is a flow chart of display control of the additional writing image in another embodiment;

FIG. 5 is a flowchart of recording of the projection image; and

FIG. 6 is a flowchart of recording of the projection image in another embodiment.

### DETAILED DESCRIPTION OF THE PREFERRED EMBODIMENTS

Hereinafter, a projector according to an embodiment of the present invention will be described using the drawings.

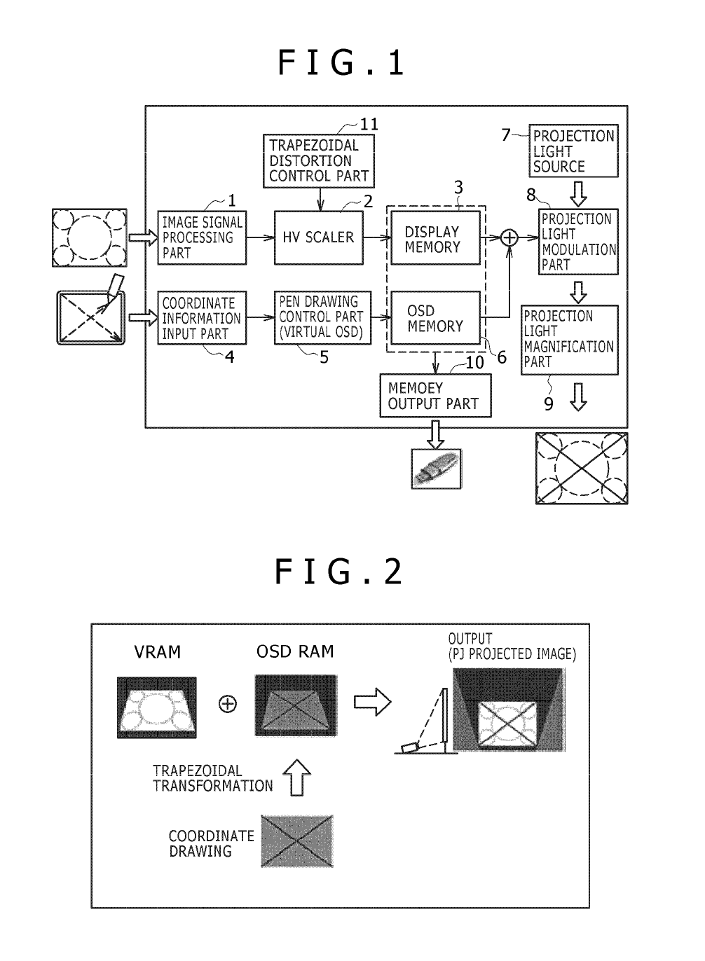

FIG. 1 is a block diagram illustrating a constitution of the projector of the embodiment. The projector is constituted by a display control part including an image signal processing part 1, an HV scaler 2, a display memory 3, a coordinate information input part 4, a pen drawing control part 5, an OSD memory 6, a memory output part 10, and a trapezoidal distortion control part 11; a projection light source 7 which emits projection light for the projector; a projection light modulation part 8 which modulates the projection light from the projection light source 7; and a projection light magnification part 9 which magnifies and projects the projection image formed in the projection light modulation part 8 to a screen or a whiteboard. Here, the projection light modulation part 8 is constituted by a transmissive or a reflective liquid crystal panel or DMD.

The image signal processing part 1 receives video image signals from a display device such as a PC connected to the projector of the embodiment, transforms the video image signals to projection image signals, and performs analog-digital sampling and IP conversion. The projection image signals of the image signal processing part 1 are transformed in scaling into a vertical direction and a horizontal direction depending on correction amounts of trapezoidal distortion by the HV scaler 2, and then stored in the display memory 3. At this time, a transformed amount by the HV scaler 2 is directed from the trapezoidal distortion control part 11. The trapezoidal distortion control part 11, in which the correction amounts of trapezoidal distortion set in the initial settings of the projector are set, controls reduction amounts in the vertical direction and the horizontal direction depending on a line position in the vertical direction of the projection image signals.

The coordinate information input part 4 is an input part of coordinate information from additional writing information setting means such as an electronic pen and a mouse. This coordinate information indicates a position of an additional writing marking on the surface of the screen or the whiteboard. Other than the electronic pen and the mouse, a tablet device which can assign coordinates may be applicable. The pen drawing control part 5 generates trajectory information of the additional writing information by connecting a plural of coordinates by straight lines based on the coordinate information of the coordinate information input part 4. The generated trajectory information is stored in the OSD memory 6. The OSD memory 6 is a frame memory for displaying a menu screen and a setup screen of the projector. Contents of the OSD memory 6 and contents of the display memory 3 in which the projection image signal is recorded are synthesized and the synthesized data is set to the projection light modulation part 8. The pen drawing control part 5 performs straight line drawing and a coordinate interpolation process in order to generate the trajectory information from the coordinate information. These processes are realized by a software drawing process by a microprocessor or a hardware drawing process by a drawing processor.

The projection image information and the additional writing image information stored in the display memory 3 and the OSD memory 6 can be recorded through the memory output part 10 into a storage device such as a USB memory connected to the projector. Subsequently, summary of the display control of the embodiment of the present invention will be described using FIG. 2.

When a rectangular shape is magnified and projected from a downward direction to an upstream direction, a size of the projected shape is different depending on a projected distance. This is trapezoidal distortion, and specifically, when the rectangular shape is projected, a trapezoidal shape in which an upper base length is longer than a lower base length is displayed. In trapezoidal distortion correction, the projected shape is previously transformed into a trapezoidal shape in which the upper base length is longer than the lower base length in such a manner that difference between the upper base length and the lower base length is corrected. This transformation is processed by the HV scaler 2, and the distortion corrected projected shape is written in the display memory 3. This is illustrated in a figure at the left side in FIG. 2.

When the coordinate information corresponding to a diagonal line of the rectangular shape is inputted from the coordinate information input part 4, a straight line corresponding to the diagonal line of the rectangular shape is drawn by the pen drawing control part 5 and a similar trapezoidal transformation to the distortion correction described above is performed and is recorded in the OSD memory 6. This is illustrated in a figure in the middle in FIG. 2.

Contents of the display memory 3 and the OSD memory 6 are synthesized and set into the projection light modulation part 8, and the trapezoidal distortion caused by oblique projection is corrected to display as illustrated in a figure at the right side of FIG. 2.

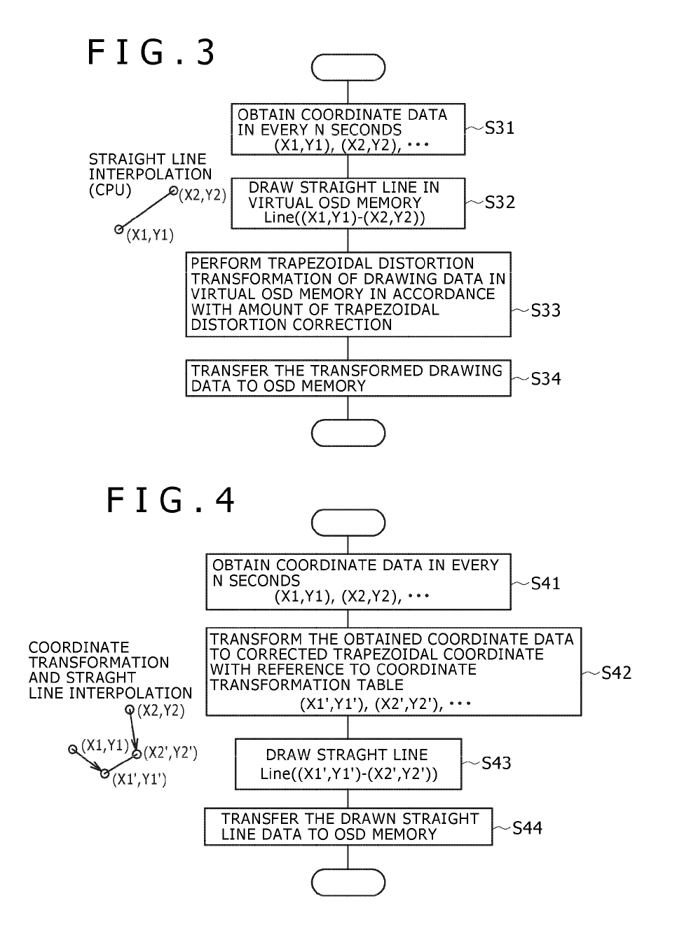

The process of the pen drawing control part 5 will be described in detail using FIG. 3 and FIG. 4. As described above, the pen drawing control part 5 writes the trajectory information of the distortion corrected additional writing information into the OSD memory 6. There are two methods for writing as described below.

One is a method illustrated in the flowchart of FIG. 3.

First, coordinate data is inputted into the coordinate information input part 4 in every N seconds, and the coordinate information input part 4 obtains coordinate values (x1, y1), (x2, y2), and the like in every N seconds (step 31). Based on two coordinate values, the pen drawing control part 5 draws straight line in which the coordinate values are set to end points on a virtual memory during predetermined time (step 32). Subsequently, trapezoidal distortion of the drawing information in the virtual memory is transformed (step 33). Then, the transformed drawing information is transferred to the OSD memory 6 (step 34).

The other method is a method illustrated in the flowchart of FIG. 4.

In this method, first, coordinate data is inputted into the coordinate information input part 4 in every N seconds, and the coordinate information input part 4 obtains coordinate values (x1, y1), (x2, y2), and the like in every N seconds (step 41). A coordinate transformation table between the rectangular coordinate and the trapezoidal coordinate is previously prepared. The coordinate values (x1, y1), (x2, y2), and the like in step 41 is transformed to a corrected trapezoidal coordinate (x1′, y1′), (x2′, y2′), and the like with reference to the coordinate transformation table (step 42). Subsequently, based on two corrected trapezoidal coordinate values, straight line in which the coordinate values are set to end points is drawn during predetermined time (step 43). Then, the straight line drawing data is transferred to the OSD memory 6 (step 44).

The method of FIG. 4 is characterized by reduction in throughput because the inputted coordinate information is transformed to the trapezoidal coordinate in the method of FIG. 4, while coordinate transformation in a region of the projection image to which writing is added is performed in the method of FIG. 3. Consequently, the method of FIG. 4 is suitable when the software drawing is processed by a microprocessor.

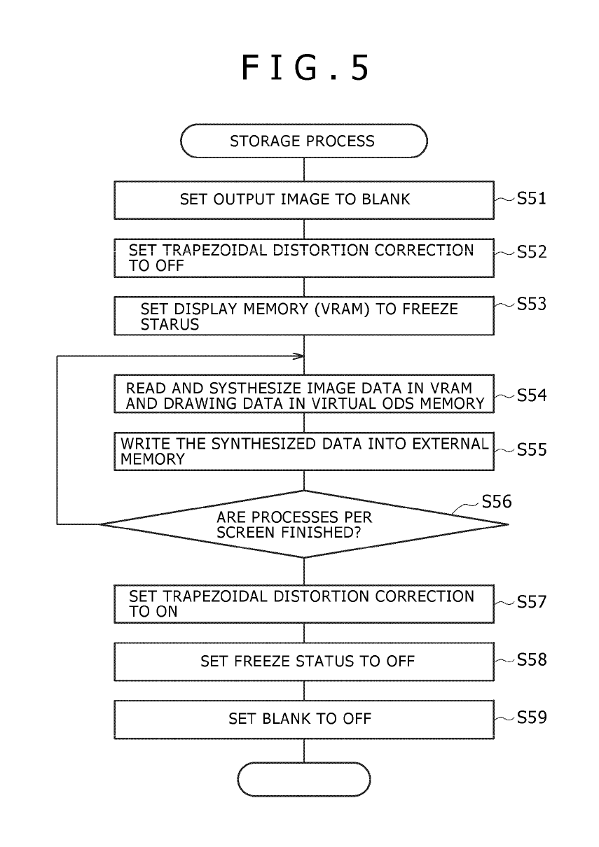

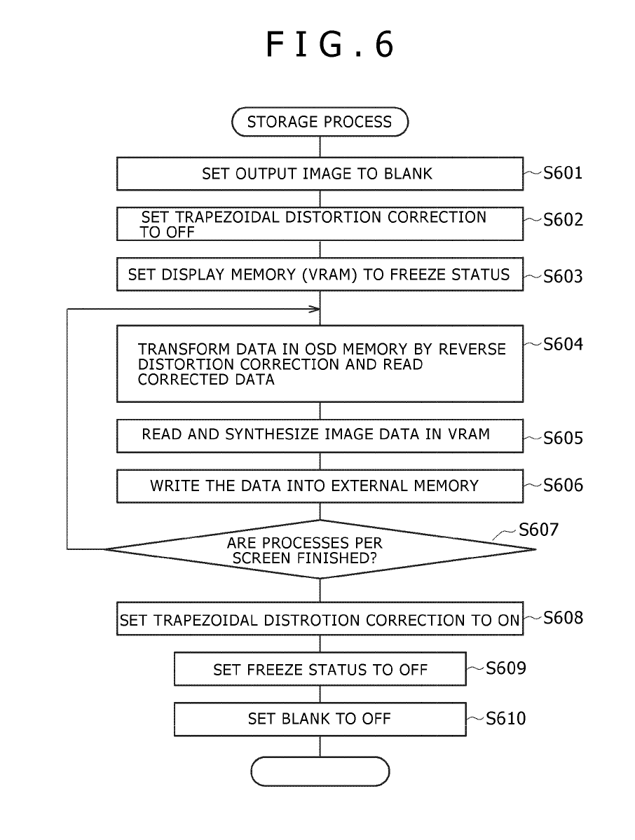

Subsequently, a method for recording the projection image with which additional writing information is synthesized into a storage device such as a USB memory connected to the projector will be described with reference to FIGS. 5 and 6.

As described above, the distortion corrected image information is stored in the display memory 3. Consequently, if the content in the display memory 3 is stored in an external storage device, the content is inadequate for direct printout. In addition, the trapezoidal distortion of the projector is different from trapezoidal distortion of other projectors having different setting conditions, and therefore, the content cannot be displayed by the other projectors. Consequently, the recording is processed in such a manner that the trapezoidal distortion of image information is not corrected. The recording is performed by the following two methods.

One method is a method illustrated in the flowchart of FIG. 5.

First, an output image of the projector is set to BLANK (step 51). Subsequently, a trapezoidal distortion correction process of the trapezoidal distortion control part 11 and the HV scaler 2 is set to OFF (step 52). Further, the display memory 3 is set to a FREEZE status (step 53).

The image data in the display memory 3 and the drawing data in the virtual OSD memory described in FIG. 3 are read and synthesized (step 54), and the synthesized data is written to an external storage device through the memory output part 10 (step 55). Processes in Steps 54 and 55 are repeated per screen (step 56), and when the processes per screen is finished, the trapezoidal distortion correction process of the trapezoidal distortion control part 11 and the HV scaler 2 is set to ON, which is opposite to the start of recording (step 57). The FREEZE status of the display memory 3 is canceled (step 58). The BLANK status of the output image of the projector is canceled (step 59).

The other method is a method illustrated in the flowchart of FIG. 6.

In this method, first, an output image of the projector is set to BLANK (step 601). Subsequently, a trapezoidal distortion correction process of the trapezoidal distortion control part 11 and the HV scaler 2 is set to OFF (step 602). Further, the display memory 3 is set to a FREEZE status (step 603).

Data in the OSD memory 6 in FIG. 4 is transformed by reverse distortion correction and the transformed data is read (step 604). The image data in the display memory 3 is read and synthesized (step 605). These data are written in the external storage device through the memory output part 10 (step 606). Processes in Steps 604, 605 and 606 are repeated per screen (step 607), and when the processes per screen is finished, the trapezoidal distortion correction process of the trapezoidal distortion control part 11 and the HV scaler 2 is set to ON, which is opposite to the start of recording (step 608). The FREEZE status of the display memory 3 is canceled (step 609). The BLANK status of the output image of the projector is canceled (step 610).

According to the methods described above, the projection image information and the additional writing information without trapezoidal distortion can be written into the external memory means.

In the embodiments described above, the output image from the projector is set to BLANK during writing of the contents in the display memory 3 and the OSD memory 6 into the external storage device. Consequently, a progress status of the writing cannot be observed from outside. Therefore, during writing, only output image in the display memory 3 may be set to BLANK; the content of the OSD memory 6 can be outputted; and a progress bar for the writing in a region where OSD memory 6 does not currently read may be displayed. When the screen is constituted as described above, the progress status of the writing into the external storage device can be observed and, as a result, the usability is improved.

When the contents of the display memory 3 and the OSD memory 6 are written into the external storage device, the contents may be written after code compression. When the code compression is performed, a use rate of the external storage device is improved and more projection images can be stored.

What is claimed is:

1. A projector in which an additional writing image is synthesized with a projection image and the synthesized image is projected and displayed, the projector comprising:
a display memory which stores trapezoidal distortion corrected projection image information;
a pen drawing control part which forms an additional writing image by straight line drawing based on display position information of an inputted additional writing image and corrects trapezoidal distortion; and
an OSD memory which stores additional writing image information being generated in the pen drawing control part and in which trapezoidal distortion is corrected,
wherein image information in the display memory and image information the OSD memory are synthesized and displayed.

2. A method for controlling image display of a projector in which an additional writing image is synthesized with a projection image and the synthesized image is projected and displayed, the method comprising:
inputting pieces of coordinate information of an additional writing image which is synthesized with a projection image and displayed;
drawing a straight line of which the pieces of coordinate information are used as edge parts;
transforming a coordinate of projection image information in accordance with a correction amount of trapezoidal distortion;
transforming a coordinate of the additional writing image in which the straight line is drawn in accordance with a correction amount of trapezoidal distortion;
synthesizing the coordinate transformed projection image information with the coordinate transformed additional writing image information; and
magnifying and projecting the synthesized projection image information.

3. The method for controlling the display of the projector according to claim 2, further comprising:
setting an output image of a projection image BLANK;
storing projection image information into a display memory without coordinate transformation in accordance with a correction amount of trapezoidal distortion;
setting the display memory a FREEZE status;
synthesizing image data in the display memory with the additional writing image formed by the step of drawing the straight line of which the pieces of coordinate information are used as the edge parts;
writing the image information synthesized in the previous step into an external storage means;
resuming the step of transforming the coordinate of the projection image information in accordance with the correction amount of the trapezoidal distortion;
canceling the FREEZE status of the display memory; and
canceling the BLANK status of the output image of the projection image,
wherein the projection image synthesized with the additional writing image is written into the external storage means.

4. A method for controlling an image display of a projector in which an additional writing image is synthesized with a projection image and the synthesized image is projected and displayed, the method comprising:
inputting pieces of coordinate information of an additional writing image which is synthesized with a projection image and displayed;
transforming pieces of coordinate information of the additional writing image to a plurality of corrected trapezoidal coordinates with reference to a coordinate transformation table;
drawing a straight line of which the pieces of corrected trapezoidal coordinate information are used as the edge parts to create an additional writing image;
transforming a coordinate of projection image information in accordance with a correction amount of trapezoidal distortion;
synthesizing the coordinate transformed projection image information with the coordinate transformed additional writing image information; and
magnifying and projecting the synthesized projection image information.

5. The method for controlling display the projector according to claim 4, further comprising:
setting an output image of a projection image BLANK;
storing projection image information into a display memory without coordinate transformation in accordance with a correction amount of trapezoidal distortion;
setting the display memory a FREEZE status;
synthesizing image data in the display memory with an additional writing image created by reverse trapezoidal correction transformation of the additional writing image created in the step of drawing the straight line of which the pieces of corrected trapezoidal coordinate information are used as the edge parts to create an additional writing image;
writing the image information synthesized in the previous step into an external storage means;
resuming the step of transforming the coordinate of the projection image information in accordance with the correction amount of the trapezoidal distortion;
canceling the FREEZE status of the display memory; and
canceling the BLANK status of the output image of the projection image,
wherein the projection image synthesized with the additional writing image is written into the external storage means.
